(19) United States
(12) Patent Application Publication
(10) Pub. No.: US 2015/0040521 A1
(43) Pub. Date: Feb. 12, 2015

(54) SLICING INTO THE PACKAGING

(71) Applicant: GEA Food Solutions Germany GmbH, Biedenkopf-Wallau (DE)

(72) Inventors: Gerd Hübner, Wilnsdorf (DE); Klaus Meyer, Breidenbach (DE)

(73) Assignee: GEA Food Solutions Germany GmbH, Beidenkopf-Wallau (DE)

(21) Appl. No.: 14/374,663

(22) PCT Filed: Jan. 23, 2013
(86) PCT No.: PCT/EP2013/051253

§ 371 Date: Jul. 25, 2014

(30) Foreign Application Priority Data
Jan. 26, 2012 (DE) 102012001391.4

(51) Int. Cl. B26D 7/32; B65B 25/06; B65B 9/04; B26D 3/16

(52) U.S. Cl. CPC B26D 7/32; B26D 3/16; B65B 25/065; B65B 25/068; B65B 9/04
USPC 53/513; 83/42; 83/23; 83/155

(57) ABSTRACT

The invention relates to a method for cutting a bar of product into slices of product by means of a cutting device. The invention also relates to a packaging machine for packaging slices of product, having a plurality of work stations and a cutting device for cutting a bar of product into slices of product. The invention further relates to a system consisting of a cutting device and a packing machine.

The present invention relates to a method of slicing an elongate product into product slices using a slicing apparatus. The present invention also relates to a packaging machine for packaging product slices, having a plurality of operating stations and having a slicing apparatus for slicing an elongate product into product slices. The present invention additionally relates to a system comprising a slicing apparatus and a packaging machine.

For foodstuff-processing purposes, for example for slicing elongate products into foodstuff slices and packaging the same, hygiene and the compactness of the machines, preferably the smallest possible machine length and/or system length, are becoming more and more important.

It is has therefore been an object of the present invention to provide a method, a packaging machine and a slicing apparatus, and/or a system comprising a packaging machine and slicing apparatus, which meets stringent hygiene requirements and in which the machine and/or the system are/is of the smallest length possible.

The object is achieved by a method of slicing an elongate product into product slices using a slicing apparatus, wherein the cut-off product slices are placed directly on a lower-sheet web or in a pack cavity.

The disclosure made in respect of this subject matter of the present invention applies equally to the other subjects of the present invention, and vice versa.

The present invention relates to a method of slicing an elongate product into product slices. This elongate product is, in particular, an elongate foodstuff product, for example an elongate sausage, cheese or ham product. An elongate product within the context of the invention, however, may also be in the form of uncured ham. This elongate product is sliced into product slices using a slicing apparatus. The elongate product here is transported continuously or intermittently in the direction of a moving, preferably rotating, blade, which severs the product slices from the front end of the elongate product. The thickness of the slices is determined by the advancement distance which the elongate product covers between two cuts. According to the invention, the cut-off product slices are placed directly on a lower-sheet web or in a pack cavity which is part of a pack, or in a pack cavity which is likewise part of the pack. The foodstuff slices, once cut off, preferably fall directly onto the lower-sheet web or into a pack cavity.

This subject matter of the present invention has the advantage that it is possible to dispense, at least for the most part, with conveying belts which are normally present following on from the slicing apparatus and by means of which the product slices are transported from the slicing apparatus to the packaging machine and, there, are fed into pack cavities. This shortens the distance within which the product slices can be contaminated with particles of dirt or germs. In addition, the system can thus be configured in a space-saving manner, which allows the system to be operated even in relatively small production facilities.

It is usually the case that a plurality of foodstuff slices are put together to form a portion. This portion is configured preferably directly on the lower-sheet web or directly in the pack cavity.

A further subject matter of the present invention is a method of slicing an elongate product into product slices using a slicing apparatus and in which the cut-off product slices are set down on a set-down table and are set down, from there, on a lower-sheet web and/or in a pack cavity.

The disclosure made in respect of this subject matter of the present invention applies equally to the other subjects of the present invention, and vice versa.

It is also the case with this subject matter of the present invention that the foodstuff slices are not transported by conveying belts from the slicing apparatus to the packaging machine. In the present case, the cutting blade has provided beneath it a set-down table, on which the cut-off product slices are set down in the first instance and, from there, are positioned on, or preferably discharged onto, the lower-sheet web and/or positioned in, or preferably discharged into, a pack cavity.

This embodiment of the method according to the invention is also distinguished by improved hygiene. Moreover, the method according to the invention saves a significantly greater amount of space than methods according to the prior art.

The set-down table preferably has at least one, preferably a plurality of, transporting means, for example endless belts which move relative to the set-down table. It is also preferable for the set-down table to be movable in at least one direction in space in a single plane, for example a horizontal plane, and/or to be rotatable about one or more axes, in particular a vertical axis and a horizontal axis. The set-down table is preferably located above the lower-sheet web or the pack cavity.

The packaging machine preferably operates cyclically, wherein, during one cycle, a plurality of, for example, pack cavities are produced, in particular by virtue of the lower-sheet web being thermoformed, filled with product slices and closed with a cover sheet or are merely filled and closed with a cover sheet. During one cycle, a so-called format of packs is established, this comprising preferably a plurality of tracks, which are oriented parallel to the running direction of the lower-sheet web, and particularly preferably a plurality of columns, which are oriented perpendicularly to the transporting direction of the lower-sheet web. As an alternative, it is also possible, however, for a format to have just one track with one or more packs.

According to a preferred embodiment of the present invention, the portions of at least one column are collected on the set-down table and then are fed, in particular discharged, directly onto a lower-sheet web or into a pack cavity. The lower-sheet web of the packaging machine is then moved on cyclically by one column, which is filled as soon as a sufficient number of portions have been sliced on the set-down table.

In a preferred embodiment of the present invention, this set-down table is also used to separate out defective portions, in which the quality of the slices does not meet the desired level and/or which do not have a sufficient number of product slices. Further preferably, the set-down table can be used to separate out initial slices, which are produced when an elongate foodstuff product is cut for the first time, and/or endpieces of the elongate foodstuff product, which it is not possible to slice in a controlled manner. One or more of these separating-out operations can take place, for example, by the set-down table moving transversely to the transporting direction of the lower-sheet web/pack cavity or, for example, moving counter to the transporting direction of the lower-sheet web/pack cavity. In particular, the defective portions, initial slices and/or the leftover pieces are preferably conveyed into a container and passed on for some other use. Incomplete portions can be used, in particular, for the purpose of completing portions.

According to a further preferred embodiment, an incomplete portion, a defective portion, at least one initial slice and/or an endpiece are collected using a collecting means before being set down, in particular falling, on the lower-sheet web or in the pack cavity. As an alternative, or in addition, the incomplete portion, the defective portion, at least one initial slice and/or the endpiece pass, in particular fall, onto the lower-sheet web and/or into the pack cavity and are removed again from there using a removal means. Use can be made, for this purpose, for example of a robot which has a collecting surface arranged optionally in the discharging region downstream of the cutting blade in order to collect the incomplete portion, the defective portion, at least one initial slice and/or an endpiece. It is also possible as an alternative, or in addition, for this robot to have a gripper, by means of which the incomplete portion, the defective portion, at least one initial slice and/or an endpiece are removed again from the lower-sheet web or from the pack cavity.

According to a further preferred subject matter of the present invention, or a further subject matter according to the invention, a communication is made to the downstream packaging machine that a portion/pack which has a defective portion, an incomplete portion, initial slices and/or an endpiece should be identified as a reject. This portion/pack is then ejected or modified to form an acceptable pack. The pack is ejected preferably once the pack has been closed with a cover sheet.

A further subject matter of the present invention is a method in which a plurality of product slices are set down in the form of a portion on a lower-sheet web and/or in a pack cavity and/or a plurality of portions are set down on a lower-sheet web and/or in a pack cavity.

The disclosure made in respect of this subject matter of the present invention applies equally to the other subjects of the present invention, and vice versa.

A plurality of product slices are preferably set down in the form of a portion on the lower-sheet web and/or in a pack cavity. The product slices here are, for example, stacked or imbricated. According to a preferred embodiment, for imbricating purposes, the lower-sheet web and/or the pack cavity are/is moved relative to the slicing apparatus, which is preferably at a standstill. As an alternative, or in addition, for imbricating purposes, the slicing apparatus is moved relative to the lower-sheet web, which is preferably at a standstill, and/or the pack cavity, which is preferably at a standstill. It is also preferable for the distance between the slicing apparatus and the sheet web and/or the pack cavity to be altered during the production of a portion. This preferred embodiment of the present invention is advantageous, in particular, in the case of a stacked pack, in order to ensure that the trajectory of each foodstuff slice in a portion is always the same.

According to a further preferred subject matter of the present invention, or a further subject matter according to the invention, a plurality of portions are arranged on a lower-sheet web and/or in a pack cavity, i.e. in a pack. These portions may be arranged one above the other or one beside the other and may be stacked or imbricated.

The disclosure made in respect of this subject matter of the present invention applies equally to the other subjects of the present invention, and vice versa.

A further preferred subject matter of the present invention, or a further subject matter according to the invention, is a method in which the cutting blade of the slicing apparatus executes non-productive cuts as the lower-sheet web or the pack cavity is being transported further.

The disclosure made in respect of this subject matter of the present invention applies equally to the other subjects of the present invention, and vice versa.

In order for the packs to be transported further, it may be necessary for the cutting blade to execute “non-productive” cuts, during which the cutting blade moves, for example in rotary and/or orbital fashion, without foodstuff slices being severed from the elongate product. These non-productive cuts can be achieved by the elongate product being drawn back from the cutting blade and/or by the cutting blade being moved away from the front end of the elongate foodstuff product. This means that, as the lower-sheet web or the pack cavity is being transported further, there are no slices cut off which would then have to be stored on an interim basis. Since the front end of the elongate foodstuff product and the cutting blade are moved away from one another during the non-productive cut, it is also the case that there are no “offcuts”, i.e. incompletely severed foodstuff slices, produced, which would then fall onto the lower-sheet web or into the pack cavity.

The lower-sheet web or the pack is preferably transported further at such a speed that it is also the case that the elongate foodstuff product cannot deform such that, despite its front end being spaced apart from the cutting blade, it passes into the latter.

A further subject matter of the present invention is a method in which a lower-sheet web and/or a pack cavity and the slicing apparatus are moved relative to one another during the slicing operation.

The disclosure made in respect of this subject matter of the present invention applies equally to the other subjects of the present invention, and vice versa.

This preferred embodiment of the present invention is advantageous, in particular, for producing portions on the lower-sheet web or in the pack cavity. The relative movement can take place in a horizontal plane and/or in a vertical plane.

A further subject matter of the present invention is a method in which a lower-sheet web and/or a pack cavity are/is inclined for the purpose of filling with at least one foodstuff slice.

The disclosure made in respect of this subject matter of the present invention applies equally to the other subjects of the present invention, and vice versa.

In the case of this preferred embodiment, the pack cavity is inclined for the purpose of filling with at least one foodstuff slice, but preferably with one portion. The feed operation takes place here preferably by way of a set-down table, which preferably has a feed belt. The oblique positioning of the pack allows the foodstuff slice or the portion to be fed very straightforwardly and without any jolting. The inclination takes place preferably about a particularly preferably horizontal axis which, in a quite particularly preferred manner, is oriented transversely to the transporting direction of the lower-sheet web or of the pack cavity.

A further subject matter of the present invention is a method in which a portion comprising a plurality of product slices is weighed during the slicing operation or immediately following the slicing operation, in the pack.

The disclosure made in respect of this subject matter of the present invention applies equally to the other subjects of the present invention, and vice versa.

In the present case, the packaging machine has a set of scales, preferably arranged beneath the cutting blade.

The foodstuff slices, which fall into the respective pack cavity or onto the lower-sheet web, are weighed immediately. This makes it possible to ensure on site that the respective pack has the required DESIRED weight. For the case where the ACTUAL weight is too low, a further one or more product slices are cut off and positioned on the lower-sheet web or in the pack cavity. For the case where the ACTUAL weight is too high, the procedure is preferably such that the control means of the machine or of the system notes the relevant pack and, once the latter has been separated in the cutting station, ejects it from the process or one or more foodstuff slices are removed from the pack.

It is particularly preferred if the individual slices are weighed as they are being fed and, just prior to the DESIRED weight being achieved, forecast calculations give rise to the DESIRED weight being achieved in a particularly specific manner, that is to say in particular excess-weight packs are avoided with a particularly high degree of probability.

A further subject matter of the present invention is a method in which the slicing apparatus has an advancing means for the elongate product and a moving, in particular rotating, cutting blade, which cuts off product slices from the elongate product, in the case of which the movement of the advancing means and/or of the cutting blade is controlled in dependence on the advancement of the lower-sheet web and/or of the packed cavity.

The disclosure made in respect of this subject matter of the present invention applies equally to the other subjects of the present invention, and vice versa.

In the case of this subject matter of the present invention, the slicing apparatus has an advancing means which moves the elongate product in the direction of the cutting blade. The slicing apparatus also has a moving, preferably rotating, cutting blade, which cuts off product slices from the front end of the elongate product. In order for the packs to be portioned or transported further, it may be necessary for the cutting blade to execute “non-productive” cuts, during which the cutting blade moves without foodstuff slices being severed from the elongate product. These non-productive cuts can be achieved by the elongate product being drawn back from the cutting blade and/or by the cutting blade being moved away from the front end of the elongate foodstuff product.

According to the present invention, at least one of the movements of the advancing means and/or of the cutting blade is controlled in dependence on the advancement of the lower-sheet web and/or of the pack cavity. In the present case, the packaging machine has the “lead” in terms of control, i.e. the movements of the slicing apparatus follow signals which are generated by the packaging machine.

A further subject matter of the present invention is a method according to which the slicing apparatus has an advancing means for the elongate product and a moving, in particular rotating, cutting blade, which cuts off product slices from the elongate product, in the case of which the advancement of the lower-sheet web and/or of the pack cavity is controlled in dependence on the movement of the advancing means and/or of the cutting blade.

The disclosure made in respect of this subject matter of the present invention applies equally to the other subjects of the present invention, and vice versa.

Reference can be made essentially to what was said in accordance with the last-described method, the present case being such that the advancement of the lower-sheet web and/or of the pack cavity is controlled in dependence on the movement of the advancing means and/or of the cutting blade. In the present case, the slicing apparatus has the lead. This method according to the invention or preferred method of the present invention is advantageous, in particular, when so-called imbricated portions are to be produced and the movement of the lower-sheet web or of the pack cavity relative to the cutting blade takes place by movement of the lower-sheet web or of the pack cavity itself.

What is said herein below applies equally to all the methods according to the invention.

Preferably a plurality of elongate products are sliced, at least temporarily, simultaneously, preferably independently of one another. For this purpose, the slicing machine according to the invention preferably has a plurality of so-called advancement routes, along which a respective elongate product is transported. In the case of a cyclic movement of the cutting blade, for example of a rotation, a plurality of product slices are cut off essentially simultaneously.

The number of products is preferably different from, in particular smaller or greater, or equal to the number of tracks of the packaging machine. In particular if the number of elongate products which are sliced simultaneously is smaller than the number of tracks, a set-down table is preferably provided, it being possible for the latter to be displaced in particular transversely to the transporting direction of the lower-sheet web or of the pack cavity and have a number of portions which corresponds to the number of tracks loaded during a single cycle set down on it before said portions are fed into the pack cavities. As an alternative, rather than all the tracks of an advancement section being filled simultaneously with a portion, at least some are filled one after the other.

As a further alternative, it is not the case, during a single revolution of the blade, that a slice is cut off from all of the elongate foodstuff products located in the slicing apparatus. This is preferably done in particular when the number of products, the elongate foodstuff products, is greater than the number of tracks of the packaging machine. In order to prevent a foodstuff slice from being severed from the respective product, the latter can be drawn back, for example, from the cutting plane.

It is preferable for the method to make use of a set-down table for adapting the number of simultaneously cut-off elongate products to the number of tracks. A person skilled in the art understands that this, clearly, also applies if just one elongate product is sliced and the number of tracks and/or the number of portions per track and cycle is greater than 1.

In a preferred embodiment of the present invention, different elongate products are sliced. It is quite particularly preferred for each portion to have product slices from different elongate products. This can be achieved, for example, in that, during the operation of slicing a single portion, a set-down table is moved such that the respective portion is arranged in varying trajectories of the slices of the respective foodstuff.

A further subject matter of the present invention is a packaging machine for packaging product slices, having a plurality of operating stations, wherein one operating station is a slicing apparatus.

The disclosure made in respect of this subject matter of the present invention applies equally to the other subjects of the present invention, and vice versa.

The present invention relates to a packaging machine for packaging product slices, having a plurality of operating stations, for example a forming station, in which pack cavities are formed, for example thermoformed, in a lower-sheet web, possibly a feed station, in which the product slices are positioned in the pack cavities, a sealing station, in which a cover sheet is sealed onto the lower-sheet web, in order to seal the filled packs hermetically, and preferably a cutting station, in which the packs are separated.

According to the invention, then, this packaging machine additionally has a slicing machine, by means of which an elongate product is divided into a multiplicity of product slices. These product slices are then packaged in packs. The slicing machine may be provided as an alternative, or in addition, to a feed station. The slicing apparatus is preferably provided in the region of the so-called feed station. It is particularly preferably located above the feed station, and therefore the cut-off foodstuff slices fall onto the lower-sheet web or into the pack cavity.

The packaging machine and the slicing apparatus preferably have a common frame. The slicing apparatus further preferably has means for guiding and/or transporting the lower-sheet web and/or the pack cavities along the packaging machine. These means can move in two opposite directions in order to generate, for example, imbricated portions.

The packaging machine is preferably a so-called form-fill-seal packaging machine (FFS packaging machine) which has a forming station in which a pack cavity is formed in a lower-sheet web. The slicing apparatus is preferably arranged downstream of the forming station and upstream of a sealing station, in which a cover sheet is sealed onto the lower-sheet web.

According to another preferred embodiment, the packaging machine is a so-called tray sealer, in the case of which prefabricated individual pack cavities are filled with contents and these pack cavities, finally are closed with a cover sheet. The pack cavities are supplied to the packaging machine in a stacked state, and therefore the tray sealer usually has a so-called separating station, in which the pack cavities are destacked, i.e. separated. The slicing apparatus is preferably arranged downstream of the pack-cavity-separating station and upstream of a sealing station, in which a cover sheet is sealed onto the pack cavity.

It is preferably the case with the tray sealer that the distance between two pack cavities is moved to a desired amount upstream of the slicing apparatus. As an alternative, or in addition, the packaging machine has means which establish the location of the respective pack cavity in the packaging machine, and therefore the transportation of the same can be controlled or regulated such that the pack cavity is located, for loading purposes, precisely beneath the trajectory of the foodstuff slices and/or in the set-down region of any set-down table which may be present.

A further subject matter according to the invention or preferred subject matter of the present invention is a slicing apparatus for slicing an elongate product into product slices, having means for guiding and/or transporting the lower sheet and/or a pack cavity.

The disclosure made in respect of this subject matter of the present invention applies equally to the other subjects of the present invention, and vice versa.

A further subject matter according to the invention or preferred subject matter of the present invention is a slicing apparatus for slicing an elongate product into product slices, having an aperture through which a packaging machine can be guided.

The disclosure made in respect of this subject matter of the present invention applies equally to the other subjects of the present invention, and vice versa.

In the case of this embodiment, the slicing apparatus has a frame with an aperture which is big enough to allow the packaging machine to be guided through. It is thus possible for the slicing apparatus to be pushed onto the packaging machine, for example from the one end of the packaging machine, and then to be displaced along the packaging machine, along or counter to the transporting direction of the lower-sheet web and/or of the pack cavity, until the slicing apparatus is in the desired position. This position can be optionally altered. For the purpose of cleaning the packaging machine and/or the slicing apparatus, the slicing apparatus can be displaced relative to the packaging machine or removed from the packaging machine. In the case of a further embodiment, the slicing apparatus is configured such that it can be pivoted, at least in part, away and/or up, preferably upward, for example in order to allow, or to facilitate, the cleaning of the packaging machine and/or of the slicing apparatus.

A further preferred subject matter of the present invention, or a further subject matter according to the invention, is an apparatus for slicing an elongate product into product slices and/or a packaging machine, having a means which prevents particles of product from passing into the pack.

The disclosure made in respect of this subject matter of the present invention applies equally to the other subjects of the present invention, and vice versa.

It is always the case, when slicing elongate products, that the blade tears off particles of product from the elongate product. The slicing apparatus according to the invention and/or the packaging machine according to the invention, then, have/has at least one means which prevents such particles from passing into the pack. The means is, for example, in the form of a metal plate or a belt which is arranged in the region of the cutting blade, preferably beneath the cutting blade and particularly preferably at least in part above the lower-sheet web or the pack cavity, and thus prevents particles of product from passing into the pack. It is also possible, however, for the means to be a gas stream, in particular an air stream, by means of which for example the particles are extracted by suction and/or blown away directly where they form or are extracted by suction and/or blown away from the pack cavity. As an alternative, or in addition, the means is in the form of a means which generates, for example, an electric charge which attracts or repels the particles of product and thus keeps them away from the pack cavity.

A further subject matter of the present invention is a slicing apparatus for slicing an elongate product into product slices, having a set-down table which, in addition, is a feeder which positions the product slices and/or portions on a lower-sheet web or in a pack cavity.

The disclosure made in respect of this subject matter of the present invention applies equally to the other subjects of the present invention, and vice versa.

In the case of this preferred embodiment of the present invention, or embodiment according to the invention, the slicing apparatus has a set-down table which is provided preferably beneath the cutting blade and onto which the foodstuff slices fall after having been cut off. This set-down table, in addition, is a feeder which positions the product slices or portions on a lower-sheet web or in a pack cavity, or discharges them onto or into the same. For this purpose, the set-down table is provided preferably with at least one, particularly preferably with more than one, endless belts which, once for example one or more portions have been completed on the set-down table, position said portions on the lower-sheet web or in a pack cavity. The endless belts can be driven together or independently of one another.

The set-down table is preferably configured in the form of a so-called shuttle belt. A shuttle belt is an endless belt which has a quickly retractable front edge which is actuated while the endless belt is preferably at a standstill. The product slices or portions thus fall essentially vertically onto the lower sheet or into the pack cavity.

Preferably, or according to the invention, the set-down table can be moved in at least one plane, in one or more directions in space which are arranged particularly preferably parallel or perpendicularly to one another. For example, the table can be moved horizontally in a plane, in at least one, preferably two, or more directions in space. As an alternative, or in addition, the set-down table is height-adjustable, i.e. it can be adjusted in height in the direction of the cutting blade and away therefrom. It is thus possible for the set-down table to be spaced apart vertically for example from the elongate product and/or from the cutting blade such that each product slice has the same falling height or specifically different falling height, in order to achieve, for example, a symmetrical set-down pattern for the product slices. It is particularly preferred for the table and/or the belts provided therewith, prior to each product slice being cut off, to be displaced by a defined distance in, for example, the horizontal direction, in order to achieve a defined imbricated pattern or, in the case of displacement in the opposite direction, for example a particularly straight stack of slices.

As an alternative, or in addition, the set-down table can be rotated about a horizontal axis. It is thus possible for the set-down table, for example once a portion has been completed, to be inclined, which facilitates the set-down operation on a lower-sheet web or the feed operation into a pack cavity. As an alternative, or in addition, the set-down table can be rotated about a vertical axis, so that, for example, circular portions are produced.

In a preferred embodiment, the set-down table is configured in a form of a set of scales, and therefore, as a portion is being sliced, it can be established further whether this portion has the desired minimum weight.

A further preferred subject matter of the present invention, or subject matter according to the invention, is a slicing apparatus for slicing an elongate product into product slices or a packaging machine, each in particular as described above, characterized by having a sensor which senses at least one quality feature of the product slices and/or of the portions.

The disclosure made in respect of this subject matter of the present invention applies equally to the other subjects of the present invention, and vice versa.

A quality feature is, for example, the temperature, the color, the shape of slice and/or the size of slice, the shape of portion and/or the size of portion, proportion of fat, so-called “blood spots”, too few or too many holes in particular in cheese and/or the presence of foreign bodies. The signal of the sensor is passed on preferably to a control means, which for example separates out poor-quality slices. For this purpose, use can be made of the set-down table, the collecting means and/or a removal means. As an alternative, or in addition, it is possible to separate out packs with a defective product, in particular following closure of the same with a cover sheet.

A further preferred subject matter of the present invention, or a further subject matter according to the invention, is a slicing apparatus for slicing an elongate product into product slices and/or a packaging machine, each in particular as described above, having a radiation means which irradiates preferably the initial slice(s) cut from the elongate product and/or the cut-off product slice and/or the sliced portion and at least partially disinfects the same in the process.

The disclosure made in respect of this subject matter of the present invention applies equally to the other subjects of the present invention, and vice versa.

According to the invention, the slicing apparatus and/or the packaging machine have/has a radiation means which irradiates the initial slice(s) from the elongate foodstuff product and/or the cut-off product slice and/or the sliced portion and at least partially disinfects the same in the process.

This embodiment of the slicing apparatus has the advantage of increasing the shelf life of the product slices in the packs produced.

The cut-off product slice is preferably irradiated on both cut surfaces. The slicing apparatus or the packaging machine preferably has a means for deflecting the beams of the radiation means specifically onto the initial slice(s) and/or the cut-off product slice and/or the sliced portion.

A further subject matter of the present invention is a packaging machine or slicing apparatus having means for altering the position of the lower-sheet web and/or of a pack cavity and of the slicing apparatus relative to one another.

The disclosure made in respect of this subject matter of the present invention applies equally to the other subjects of the present invention, and vice versa.

It is thus possible, for example, to alter the vertical distance between the cutting blade and the transporting plane of the lower-sheet web and/or of a pack cavity. As an alternative, or in addition, the angle at which the slicing apparatus, in particular the cutting blade, and/or the advancing unit of the elongate product are/is arranged relative to the transporting plane of the lower-sheet web or of the pack cavity is altered.

The aforementioned measures make it possible to alter, for example, the falling height, the falling angle or the falling curve in relation to the plane in which the lower-sheet web or the pack is guided.

A further subject matter of the present invention is a system comprising a slicing apparatus and a packaging machine, having a common control means and/or a common operating unit.

The disclosure made in respect of this subject matter of the present invention applies equally to the other subjects of the present invention, and vice versa.

A further subject matter of the present invention is a slicing apparatus and/or a packaging machine, each in particular as described above, in the case of which the region of the blade and/or the discharging region of the cut-off foodstuff slice and/or the feed region is provided with a negative pressure and/or a modified atmosphere.

The disclosure made in respect of this subject matter of the present invention applies equally to the other subjects of the present invention, and vice versa.

According to this subject matter of the present invention, the operations of cutting off and/or of discharging and/or of feeding the respective foodstuff slice take place under an atmosphere which is modified in comparison with the atmosphere of the surroundings. This modified atmosphere is preferably also present in the region of the lower-sheet web or of the pack cavity. For example it is possible for the blade and/or the discharging region and/or the feed region to be at least partially encapsulated and to be subjected to negative pressure and/or for a gas with a composition other than air to be introduced into said encapsulated region.

The negative pressure and/or the modified atmosphere then preferably still enclose the cut-off slice at least temporarily in the pack, in particular until the latter is closed with a cover sheet.

It is possible to combine with one another as desired all the features of all the subjects according to the invention or preferred subjects of the present invention.

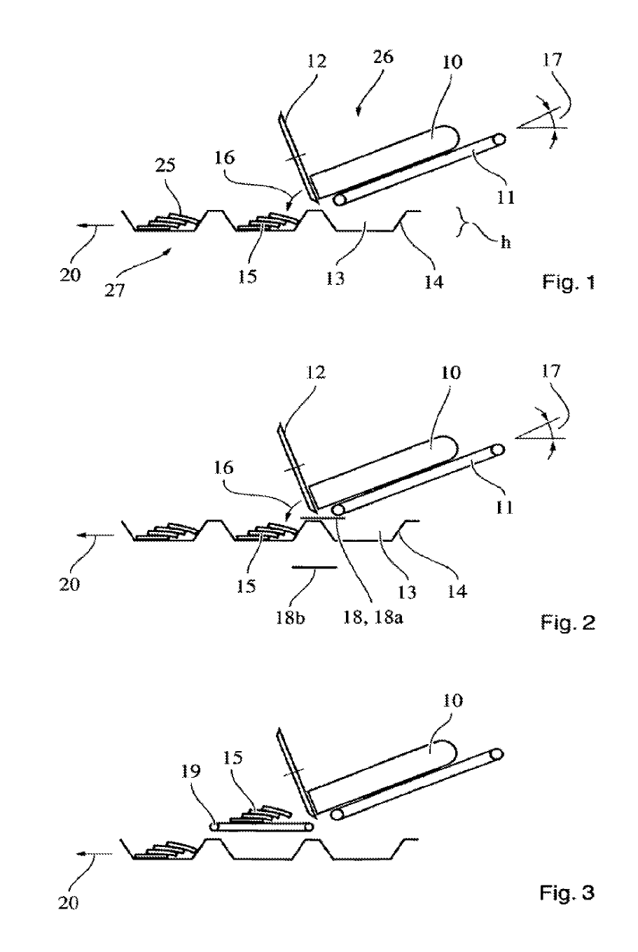

The invention will be explained herein below with reference to FIGS. 1-6. These explanations are merely by way of example and do not limit the general concept of the invention. The explanations apply equally to all the subjects of the present invention.

FIG. 1 shows a first embodiment of the present invention.

FIG. 2 shows the apparatus according to the invention with a particle catcher.

FIG. 3 shows an apparatus with a set-down table.

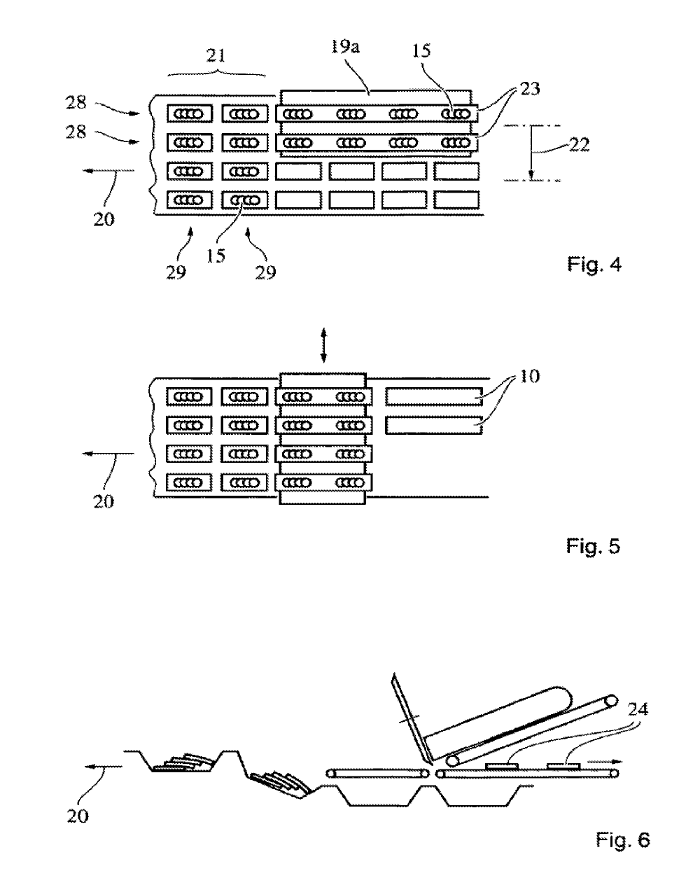

FIG. 4 shows an embodiment for the purpose of loading a format.

FIG. 5 shows an embodiment in which the number of sliced elongate products is smaller than the number of packs which are to be filled in a track.

FIG. 6 shows the inclination of the pack cavities as they are being filled.

FIG. 1 shows the packaging machine 27 according to the invention. The packaging machine, in the present case, is a so-called form-fill seal packaging machine in which a lower-sheet web 14 is transported, in particular cyclically, along the packaging machine, in this case from right to left, as indicated by the arrow 20. The packaging machine 27 is illustrated merely schematically and, in the present case, has an upstream (not illustrated) forming station, in which the pack cavities 13 are formed in the lower-sheet web, in particular under the influence of pressure and heat. These pack cavities are then transported, in the direction of the arrow 20, into the region of a slicing apparatus 26, which, according to the invention, is part of the packaging machine. This slicing apparatus has an advancing unit 11, for example an endless belt, and a moving, in this case rotating, cutting blade 12. An elongate product 10 is transported by means of the advancing unit 11 in the direction of the cutting blade, which cuts off foodstuff slices 25 from the front end of the elongate product, said foodstuff slices falling, along a falling curve, directly into the pack cavity 13, which is symbolized by the arrow 16. The thickness of the foodstuff slice is defined by the advancement of the elongate product 10 between two cuts. In the present case, the portion, which comprises a plurality of product slices 25, is imbricated, i.e. the slices overlap one another only partially. In order to achieve this, either the lower-sheet web 14 or the pack cavity is transported a certain distance in or counter to the transporting direction 20 of the lower-sheet web 14 between the operation of two foodstuff slices being discharged. As an alternative, or in addition, it is possible for the slicing apparatus 26 to be displaced, at least in part, relative to the lower-sheet web 14 and/or the pack cavity 13, in order to produce an imbricated portion. It is also possible to alter preferably the position of the slicing apparatus 26 relative to the transporting plane of the lower-sheet web 14 and/or of the pack cavity 13. This can be achieved by the position of the slicing apparatus being altered and/or by the position of the transporting plane of the lower sheets and/or of the pack cavity being altered. For example it is thus possible to alter the falling height h. As an alternative, or in addition, it is possible to alter the supply angle 17 of the elongate products. Both measures result alone, or in combination, in the trajectory of the foodstuff slices being altered. A person skilled in the art is aware that a plurality of elongate products 10 arranged one behind the other, as seen in relation to the plane of the paper, can be sliced simultaneously by the blade 12. This embodiment is advantageous, in particular, when the packaging machine also has a plurality of tracks, i.e. when a plurality of packs which are to be filled are arranged one behind the other, as seen in relation to the plane of the paper. As soon as a portion is arranged in the finished state in the pack cavity, the lower-sheet web and/or the pack cavity are/is transported further, until an empty pack cavity is located in the discharging region of the slicing apparatus. During this time, it is not permitted in the present case, for any product slices to be cut off from the elongate product. This is done preferably by the cutting blade 12 executing non-productive cuts, i.e. continuing to rotate, preferably at an unaltered rotational speed, without foodstuff slices 25 being cut off from the elongate product. This is achieved preferably in that the front end of the elongate product 10 is drawn back from the cutting blade, for example by the advancing unit 11, and/or in that the cutting blade 12 is moved away from the front end of the elongate foodstuff product, preferably parallel to the axis of rotation thereof. The non-productive cuts are executed preferably until an empty pack is located in the discharging region of the slicing apparatus.

FIG. 2 shows essentially the embodiment according to FIG. 1, although in the present case a particle catcher 18 is present in addition, in order to prevent particles which are torn off during the operation of cutting from the elongate product from passing into the pack. In the present case, the particle catcher is an endless belt with an upper strand 18a and a lower strand 18b, wherein the upper strand 18a is guided above the pack cavity 13 or the lower-sheet web 14 and the lower strand 18b is guided beneath the lower-sheet web 14 or pack cavity 13. It is preferably the case that the endless belt is provided such that it can be moved transversely to the transporting direction 20, for circulation preferably about two rollers (not illustrated). It is thus possible for particles which are deposited on the particle catcher to be transported away from the discharging region of the slicing apparatus and to be removed from the particle catcher for example by a cleaning means, for example a scraper. This allows torn-off particles to be transported away continuously or intermittently.

FIG. 3 shows an embodiment of the packaging machine according to the invention, or of the slicing apparatus according to the invention, which corresponds essentially to the embodiment of the packaging machine according to FIG. 1, but, in the present case, has a set-down table 19. The cut-off product slices 25 fall onto the set-down table 19 and are configured thereon, preferably to form portions 15. It is preferably the case that a plurality of portions are arranged on the set-down table simultaneously or one after the other.

It is preferably the case that a plurality of portions are formed, or collected, on the set-down table 19 before being set down on the lower-sheet web 14 or fed into a pack cavity 13. For this purpose, the set-down table has preferably at least one transporting belt, in this case an endless belt, which rotates, in the present case, in the counterclockwise direction as soon as one or more portions have been completed. The movement of this transporting belt can also be utilized for configuring a portion, for example for imbricating purposes. The respective portion falls or slides from the set-down table 19 into the pack 13. It is preferably possible for the set-down table to be moved as a whole, or in part, in a plane, for example a horizontal plane, in two directions in space. This can take place by movement of the set-down table as a whole and/or only in part, for example the endless belt. It is further preferable for the set-down table to be height-adjustable, i.e. for it to be possible for the distance between the set-down table and the cutting blade 12 to be altered. It is quite particularly preferable for the set-down table 19 to be pivoted and/or rotated about at least one horizontal and/or vertical axis. The set-down table may have one or more transporting belts, which can be operated preferably separately from one another.

FIG. 4 shows a plan view of the packaging machine according to the invention or the slicing apparatus according to the invention. It can be seen that the advancement section 21, by which the lower-sheet web 14 and/or the pack cavities 13 are transported further during a single cycle, comprises, in the present case, two columns 29 each with four tracks 28. In the present case, the set-down table 19 is of wide enough configuration (horizontal extent in the direction transverse to the transporting direction) for it to be possible for two completed portions to be fed simultaneously into the pack cavities in two tracks. At the same time, the set-down table 19 is of long enough configuration (horizontal extent parallel to the transporting direction) for it to be possible for said table to accommodate in full at least the portions for a withdrawal section for two tracks. In the present case, it is possible for even the portions for the entire withdrawal section (two columns and four tracks) to be accommodated simultaneously by the set-down table. In the present case, the set-down table 19 has two transporting belts 23, in this case two endless transporting belts, which can be driven together or independently of one another. In order for it also to be possible for the two lower tracks of the withdrawal section to be loaded with portions 15, the set-down table 19 is displaced in the direction 22 of the lower tracks once the portions have been set down in the upper tracks.

FIG. 5 shows a slicing apparatus in which two elongate products 10 are sliced simultaneously. It is also the case here that the packaging machine according to the invention or the slicing apparatus according to the invention has a set-down table which, as symbolized by the double arrow, is moved transversely to the transporting direction 20, in order to be able to supply all the tracks 28 with portions 15, although the number of simultaneously sliced elongate products 10 is smaller than the number of tracks which are to be charged simultaneously.

FIG. 6 shows a further embodiment of the slicing apparatus according to the invention or of the packaging machine according to the invention. In the present case, the set-down table is also, at the same time, an ejecting mechanism, which ejects unsatisfactory portions or initial slices 24. This takes place here by the transporting belts of the set-down table being moved in the clockwise direction and insufficient portions 24 being transferred to a further transporting belt, which removes them from the apparatus according to the invention. It is also the case here that the pack cavity, for filling purposes, is inclined relative to the transporting direction 20, so as to facilitate the filling operation. Also in the present case, the transporting plane of the lower-sheet web and/or of the pack cavities is raised.

### LIST OF DESIGNATIONS

10 Elongate product
11 Advancing means
12 Blade, specifically non-round
13 Pack cavity
14 Lower-sheet web
15 Portion
16 Discharging direction
17 Supply angle of the elongate products
18 Means of avoiding contamination of the packs, particle catcher
18a Cross section of the upper strand of a transverse transporting belt
18b Cross section of the lower strand of a transverse transporting belt
19 Set-down table
20 Transporting direction of the sheet with pack cavities
21 An advancement section
22 Movement direction of the feed belt for filling the other tracks
23 Transporting belt
24 Waste
25 Product slices
26 Slicing apparatus, slicer
27 Packaging machine
28 Track
29 Columns
h Distance between product support and pack cavity and/or sheet web

What is claimed is:

1. A method of slicing an elongate product into product slices using a slicing apparatus,
wherein the cut-off product slices fall directly onto a lower-sheet web or into a pack cavity
wherein an incomplete portion, a defective portion, at least one initial slice and/or an endpiece are separated out sing a collecting means and/or a removal means.

2-33. (canceled)

34. The method according to claim 1, wherein a lower-sheet web and/or a pack cavity and the slicing apparatus are moved relative to one another during the slicing operation.

35. The method according to claim 1, wherein a lower-sheet web and/or a pack cavity are/is inclined for the purpose of filling with at least one foodstuff slice.

36. The method according to claim 1, wherein a portion comprising a plurality of product slices is weighed during the slicing operation or immediately following the slicing operation, in the pack.

37. The method according to claim 1, wherein the slicing apparatus has an advancing means for the elongate product and a moving, in particular rotating, cutting blade, which cuts off product slices from the elongate product, and in that the movement of the advancing means and/or of the cutting blade is controlled in dependence on the advancement of the lower-sheet web and/or of the pack cavity.

38. The method according to claim 1, wherein the slicing apparatus has an advancing means for the elongate product and a moving, in particular rotating, cutting blade, which cuts off product slices from the elongate product, and in that the advancement of the lower-sheet web and/or of the pack cavity is controlled in dependence on the movement of the advancing means and/or of the cutting blade.

39. The method according to claim 1, wherein a plurality of elongate products are sliced simultaneously.

40. The method according to claim 39, wherein the number of elongate products is equal to, or differs from, the number of tracks of the packaging machine.

41. The method according to claim 39, wherein a set-down table is used for adapting the number of simultaneously sliced elongate products to the number of tracks.

42. The method according to claim 39, wherein the elongate products are different, and in that each portion has product slices from different elongate products.

43. The method according to claim 1, wherein the cutting blade of the slicing apparatus executes non-productive cuts as the lower-sheet web or the pack cavity is being transported further.

44. The method according to claim 40, wherein a set-down table is used for adapting the number of simultaneously sliced elongate products to the number of tracks.

45. The method according to claim 44, wherein the elongate products are different, and in that each portion has product slices from different elongate products.

46. A packaging machine for packaging product slices, having a plurality of operating stations, wherein one operating station is a slicing apparatus.

47. The packaging machine as claimed in claim 46, characterized in that it is an FFS packaging machine which has a forming station, in which a pack cavity is formed in a lower-sheet web, and in that the slicing apparatus is arranged downstream of the forming station and upstream of a sealing station, in which a cover sheet is sealed onto the lower-sheet web.

48. The packaging machine as claimed in claim 46, characterized in that it is a tray sealer which has a pack-cavity-separating station, in which the pack cavities are separated, and in that the slicing apparatus is arranged downstream of the pack-cavity-separating station and upstream of a sealing station, in which a cover sheet is sealed onto the pack cavity.

49. A slicing apparatus for slicing an elongate product into product slices, characterized in that it has means for guiding and/or transporting a lower-sheet web and/or a pack cavity.

50. The slicing apparatus for slicing an elongate product into product slices and/or the packaging machine in particular as claimed in claim 49, characterized by having a means which prevents particles of product from passing into the pack.

51. The slicing apparatus and/or the packaging machine as claimed in claim 49, wherein the means is a movable belt which is provided above and beneath the lower-sheet web and/or the pack cavity.

52. The slicing apparatus and/or the packaging machine as claimed in claim 49, wherein the means is an air stream or an electric means.
